(19) United States
(12) Patent Application Publication
(10) Pub. No.: US 2022/0232688 A1
(43) Pub. Date: Jul. 21, 2022

(54) SYSTEM AND METHOD FOR INCORPORATING SPACE AND DEVICE-BASED RULES ENGINE IN AN IoT ENVIRONMENT (ACL)

(71) Applicant: Gooee Limited, St. Albans (GB)

(72) Inventors: Simon COOMBES, St. Petersburg, FL (US); Lyle SCOTT, St. Petersburg, FL (US); Lourdes Molina MORAN, Delray Beach, FL (US); Rigel Ken TRAJANO, Saint Petersburg, FL (US); Shmuel SILVERMAN, Novato, CA (US)

(21) Appl. No.: 17/606,324

(22) PCT Filed: Apr. 24, 2020
(86) PCT No.: PCT/IB2020/000309

§ 371 Date: Oct. 25, 2021

Related U.S. Application Data
(60) Provisional application No. 62/838,732, filed on Apr. 25, 2019.

(51) Int. Cl. H05B 47/19; H05B 47/165; H04L 12/28

(52) U.S. Cl. CPC H05B 47/19; H05B 47/165; G16Y 40/30; H04L 12/2823; H04L 12/2816

(57) ABSTRACT

The present invention is a system for providing rapid response and controlling one or more devices positioned in one or more spaces connected in an IoT setting, including: one or more sensors associated with one or more electronic devices configured to sense and capture environmental, electronic device and human activities related data in real time in one or more selected spaces; at least one device for exchanging data: and, at least one gateway configured to gather and communicate the sensed data from the one or more sensors to at least one database, in which the database is connected to at least one gateway on one side and to at least one cloud server. The at least one cloud server is communicatively coupled to a space and device-based rules engine/module installed with one or more logical actions and response scripts, wherein said one or more logical actions and response scripts are configured to control space and device related parameters within the one or more selected spaces in the IoT setting.

### CROSS REFERENCE TO RELATED APPLICATION

This application claims priority from U.S. 62/838,732 filed 25 Apr. 2019, the content of which is incorporated herein by reference in its entirety.

### FIELD OF THE INVENTION

The present invention is directed to a system and method for incorporating one or more space and device-based rules engines or modules for providing rapid response and controlling one or more devices connected in an IoT environment or setting. In particular, the system is capable of incorporating rules both manually and/or automatically and can handle low level control decisions at a faster rate. More particularly, the system is capable of incorporating rules both manually and/or automatically and can handle low level control decisions at a faster rate.

### BACKGROUND

The “Internet of Things” refers to the interconnection of uniquely-identifiable embedded devices within the Internet infrastructure. Ultimately, IoT is expected to result in new, wide-ranging types of applications in which virtually any type of physical things may provide information about itself or its surroundings and/or may be controlled remotely through client devices over the internet or a cloud server.

IoT development and adoption has been slow due to issues related to connectivity, power, and a lack of standardization. Currently, there is no standard platform that allows developers to design and offer new IoT devices and services. For one to enter the IoT space, a developer must design an entire IoT platform from the ground up. This results in each provider using proprietary techniques for designing and connecting the IoT devices, therefore, making the adoption of multiple types of IoT devices burdensome for end users. In addition, there are issues around protecting individual's privacy and identity when using high resolution image sensors and, how to combine multiple sensors without knowing which will be available at production time.

For example, in a typical IoT environment there are a number of IoT light output devices that are stationary and are expected to remain in a particular location within the environment. Examples of stationary IoT light output devices can include ceiling lights, desk lamps and floor lamps (mostly stationary), a monitor display, and so on. These devices are typically positioned to provide adequate lighting in a particular region of the IoT environment, this can be a room, building, etc.

For example, six recessed, stationary lights in a kitchen of an IoT environment can be configured to project light in a direction to illuminate the kitchen in order to achieve a particular target lighting effect. Mobil IoT light output devices (e.g. integrated flashlights, display screens, etc.) can also project light into various regions of the IoT environment as the mobile device(s) are moved by users through the IoT environment. Today, if a user wants to manipulate or adjust the lighting of a mobile devices light output, or of a stationary devices light output, the user would need to manually adjust the device/light (e.g. using a dimming switch, an ON/OFF switch, etc.).

In another example, specifically in switching devices for an end-user computer system or an administrator system in a smart lighting IoT system, the user could utilize access control lists (ACL) of control data to avail rapid response and control by switching the layer 2 packets. However, there is a need for a system and method for incorporating rules both manually and automatically and handling low level control decisions at a faster rate.

There is a desire to control one or more devices connected in an IoT environment. For example, in a smart lighting system, it is advantageous to utilize a system and method to incorporate rules both manually or automatically and handling low level control decisions at a faster rate. Further, there is a desire to distribute these decisions to one or more lower level control devices such as a control gateway. In a preferred embodiment, scenario, a control gateway could be able to control connected electronic devices in an IoT environment, for example, lighting devices, with an oversight of cloud servers.8

The field of IoT development and adoption has been slow due to issues related to connectivity, power, and a lack of standardization. There is currently no standard platform to allow developers to design and offer new IoT devices and services. For this problem to be solved, there is a need to design an entire IoT platform from the ground up, including the network protocols and infrastructure, hardware, software and services needed to support the desired IoT implementation.

### SUMMARY OF THE INVENTION

The present invention is a system for providing rapid response and controlling one or more devices positioned in one or more spaces connected in an IoT setting, the system comprising: one or more sensors associated with one or more electronic devices configured to sense and capture environmental, electronic device and human activities related data in real time in one or more selected spaces; at least one device for exchanging data: and, at least one gateway configured to gather and communicate the sensed data from the one or more sensors to at least one database, in which the database is connected to at least one gateway on one side and to at least one cloud server. The at least one cloud server is communicatively coupled to a space and device-based rules engine/module installed with one or more logical actions and response scripts, wherein said one or more logical actions and response scripts are configured to control space and device related parameters within the one or more selected spaces in the IoT setting. By communicatively coupled is meant two or more devices are connected so as to transmit data, signals, vocal communications, etc. from one device to another.

An IoT setting may be an intranet setting, an internet setting or a system configured to function as either an intranet or an internet. An example of an intranet as an IoT setting may be a network between two geographically close structures such as but not limited to, two buildings owned by the same entity with network a communication system(s) between the two buildings but with communication inaccessible to and from an external network such as the world-wide web. An internet IoT setting is a network able to be connected to other networks usually through the world-wide web.

The present invention is also directed to a method for providing rapid response and for controlling one or more devices connected within an IoT environment, the method comprising the steps of: collecting one or more data regarding status information of one or more devices in one or more spaces, via one or more spaces within the IoT environment; receiving all sensed data from multiple sensors within the IoT environment, via a wireless network, by at least one local gateway wherein the multiple sensors are included in the one or more devices; collecting all sensed data from at least one local gateway by one or more databases and sending the data to a remote cloud server system; processing and co-relating the receiving input data and sending one or more logical actions and response scripts by at least one cloud server to the distributed databases; sending output control data from the at least one databases to the one of the at least one local gateways that is associated with a particular space or spaces; and, controlling space and device related parameters via received control data within the one or more spaces within the IoT environment.

An object of the invention is to present a system and method for utilize one or more space and device-based rules engines or modules for providing rapid response and controlling one or more devices connected in an IoT environment or setting.

A second object of the invention is to supply a system and method of processing or incorporating rules both manually and/or automatically and can handle low level control decisions at a faster rate.

A third object of the invention is to describe a system and method of processing and/or incorporating rules applied to a lighting system.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a schematic view of a rules-based IoT system configured to control sensors located at least one room or space;

FIG. 2 depicts database operations and distributed rules and access controls across the system in an IoT environment having a plurality of spaces and utilizing a plurality of databases;

FIG. 3 illustrates examples of sensors and their examples of data collected by the sensors;

FIG. 4 below illustrates the system operations and actions syntax;

FIG. 5 is an example of possible operations incorporated into the system of the present invention; and

FIG. 6 is a rapid response and control flow chart illustrating the methods for providing rapid response and controlling one or more devices connected in an IoT environment.

### DETAILED DESCRIPTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

The system will comprise one or more sensors associated with a plurality of electronic devices that are configured to sense and capture environment activity. The environmental activity can include the electronic device(s) and human activities related data in real time.

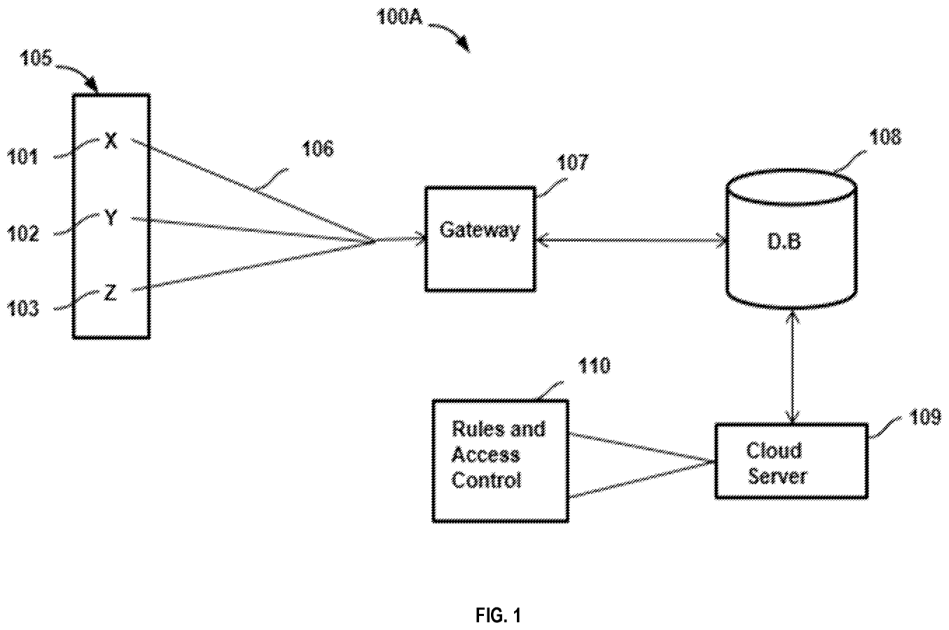

As depicted below in FIG. 1, the system includes at least one selected room or space 105 with one or more sensors 101, 102, 103, connections to a gateway 107 to gather and communicate data to a database 108, and at least one gateway connected from the database to the cloud server 109, with the cloud server 109 communicatively coupled to a space and device-based rules engine/module 110 installed with one or more logical actions and response scripts, configured to control space and devices within at least one selected space within an IoT environment. In an embodiment, connections 106 may be wireless connection(s). The data base 108 ‘reflects’ or transmits information and the state of devices and sensors within the room 105. This reflection is bi-directional and supports local and cloud-based state control. By “bi-directional” is meant that information including the state of devices and sensors is transmitted both to and from the gateway(s) 107 and to and from server(s) 109. Server 109 may be a cloud server such as those know to person skilled in the art. Server 109 manages this database information which in turn reflects states back into the system (100A) and a set of rules (110) to control this system.

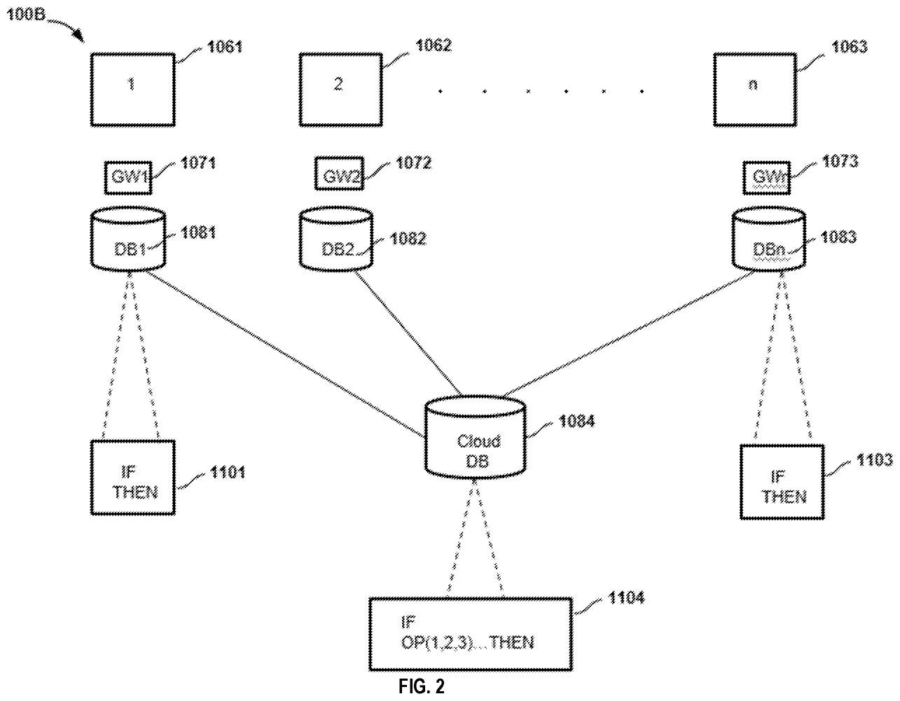

FIG. 2 depicts database operations and distributed rules and access controls across the system in an IoT environment. The distributed database is configured to send and receive information and the state of devices and sensors incorporated within the space of an IoT environment. These distributed databases both receive and send data bi-directionally and support local and cloud-based state control. Demonstrated is the distribution of the access control rules ledger between the cloud server DB 1084 and N different spaces, each with its own gateway GW1 1071 to GWn 1073 and database DB1 1081 to DBn 1083. Each local database reflects the current state of every device and sensor and the set of rules that govern its associated device. The cloud server DB 1084 includes a combined view of all the spaces and devices and sensor states and rules. Any rule change or information changes is distributed in real time between the database and when conflicts are being resolved based on a set of rules. The cloud server ledger 1104 can handle rules that both inter and intra spaces, while the local gateways 1071 . . . 1073 can handle only intra ledger. As previously described, any rule change or information or data from the sensors are distributed in real time. Databases 1081 and 1083 are shown connected directly to individual rules sections 1101 and 1103, respectively while database 1082 transmits information and data to and receives control instructions or prompts from or through server 1084.

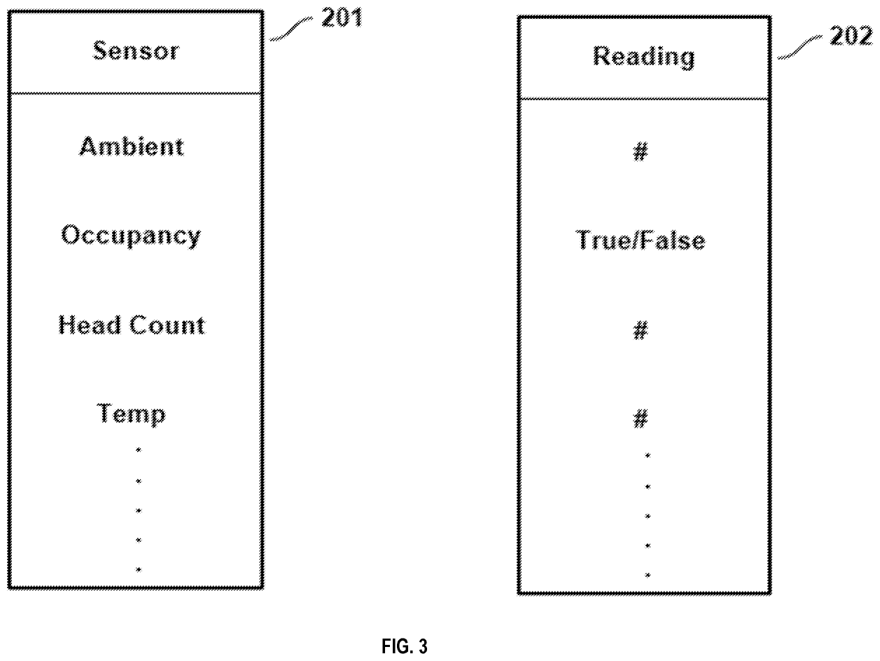

FIG. 3 illustrates examples of sensors 201 and their types 202 of readings.

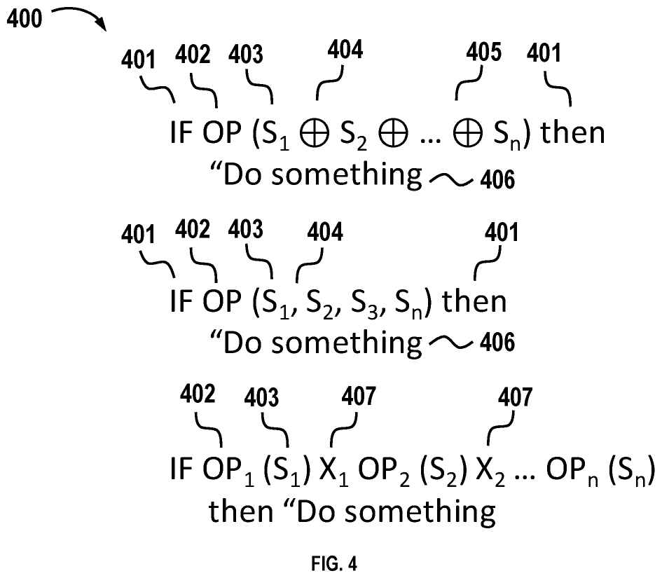

FIG. 4 below illustrates the operations and actions syntax. In this system, the action response syntax is in the form of IF . . . THEN. An example of such logic is, IF ‘some logic is true’ THEN ‘do X’. The logic is based on the operations and operation on operations and the level of detail are in the sensor readings.

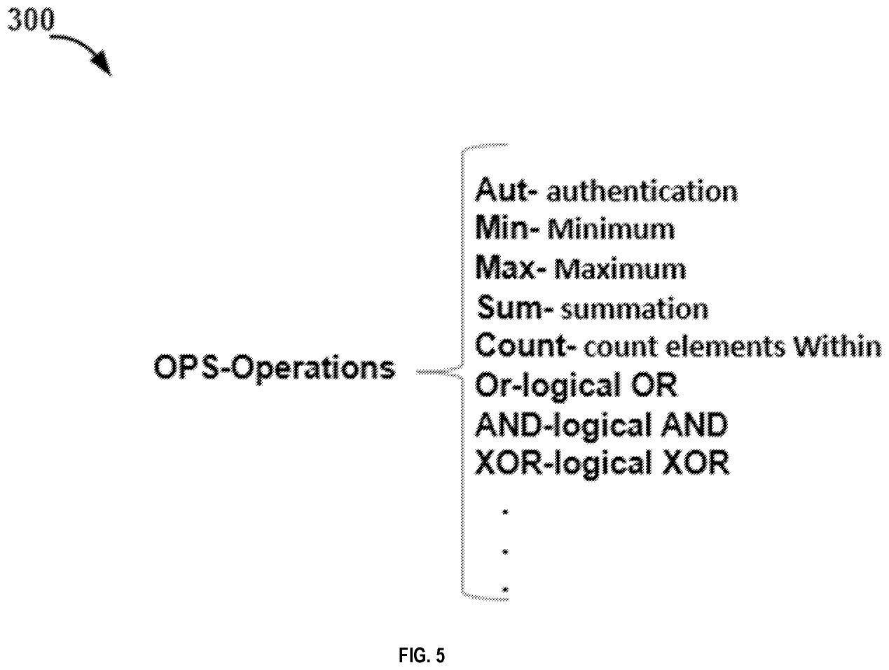

FIG. 5 depicts an example of possible operations 300 incorporated into the system 100A. This list is not meant to be all inclusive as many operations are not shown in FIG. 5.

A more specific example of how this operations and action syntax would work in a smart lighting system would be as follows:
IF Aut(S1, S2, S3) AND Sum(S1, S3)>32.55 AND D2<32, THEN ‘Turn OFF the lights in Space (S1, S2, S3).

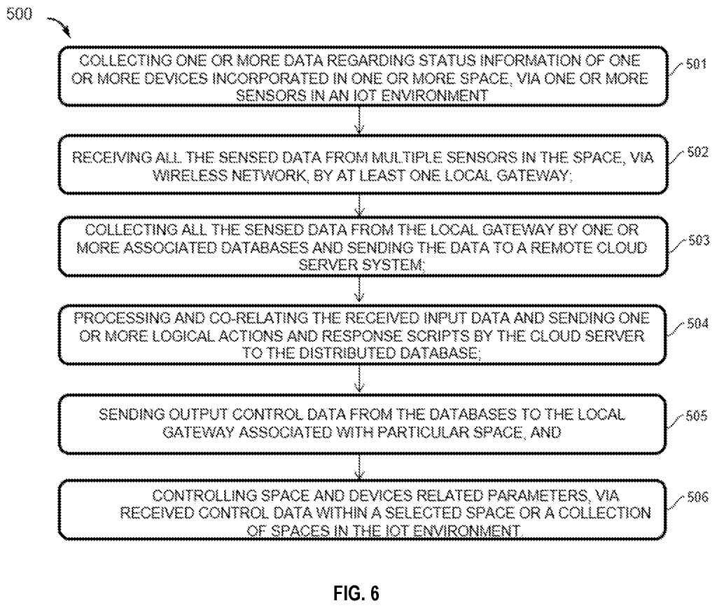

FIG. 6 depicts a high-level flow chart illustrating the methods for providing rapid response and controlling one or more devices connected in an IoT environment or setting.

API (application programming interface) endpoints are filterable by the attributes defined by the REST (Representational State Transfer) data model. True/False filters using Boolean filters can be used. There can be default ID filters, tag filters, Date/Time filters, default string filters, and filtering by customer and building the system supports equal(=) operator.

Devices can Have two Possible Paths:
1. Device->Gateway->Space->Building->Customer
2. Device->Connected Product->Space->Building->Customer

Gateway Devices can Have 1 Possible Path:
1. Gateway->Space->Building->Customer

Mesh Access Point Devices can Have 1 Possible Path:

1. Mesh Access Point->Gateway->Space->Building->Customer

### RULES

Condition Groups describe a set of conditions applied to one or more devices in a space using a specific function. When a rule is evaluated in real-time, each condition group will be evaluated in order, and each Boolean result combines via its ‘logical operator’ with the next condition group's evaluation result. This operation is left-associative.

There are two types of rules, property-based rules and event-based rules. Property-based rules are composed of condition groups, aka the grouping of conditions across one or more devices of a space that specify desired values for the meta of each device. Property-based rules execute their operations when their condition groups are met as a whole and employ a locking mechanism to ensure that the same rule won't keep evaluating once the intended effects are achieved.

Property-Based Rules

For this to be possible, there are complex constraints in that the name and space must form a unique pair, the space must have a ‘data_service_id’, and the space must have one or more devices. For example, complex constraints include:

The function field of a condition group determines how to apply its conditions to its devices. There are two types of functions: Boolean and numeric functions.

Event-Based Rules

Event-based rules are composed of a single condition which specifies a device and an action. When the specified action occurs on the specified device, the rule will execute its operations. Complex constraints include:

An event-based rule condition is an object that describes the action type and parameters required for the rule to trigger. An example of the data model is shown below:

```
{
  “condition”: {
    “action”: “button_pressed”,
    “variable”: “button_number”,
    “operator”: “=”,
    “value”: 1
  }
}
```

The system is configured to recognize particular sensors in the elected space(s) when they are incorporated into the system. Thus, both property-based rules and event-based rules are independent of the types of sensors or devices present in a specific space. For example, if an incandescent light bulb is replaced with a color temperature sensor, the relevant IF . . . THEN rule will still respond to the same property-based and/or event-based conditions.

While the above discussion is directed toward lighting systems and luminaires, persons of skill in the art will recognize that other types of systems may use a rules-based system for providing rapid response and controlling one or more devices connected in an IoT setting. Examples of such systems include, but are not limited to, botanical gardens and microchip manufacturing facilities in which environmental sensors, e.g. temperature and humidity sensors, can be controlled with a rules-based system, and chip manufacturers.

Thus it is seen that the objects of the invention are efficiently obtained, although changes and modifications to the invention should be readily apparent to those having ordinary skill in the art, which changes would not depart from the spirit and scope of the invention as claimed.

1. A system for providing rapid response and controlling one or more devices positioned in one or more spaces connected in an IoT setting, comprising:
a. one or more sensors associated with one or more electronic devices configured to sense and capture environmental, electronic device and human activities related data in real time in one or more selected spaces;
b. at least one device for exchanging data: and,
c. at least one gateway configured to gather and communicate the sensed data from the one or more sensors to at least one database, wherein the database is connected to at least one gateway on one side and to at least one server; and,
d. wherein the at least one server is communicatively coupled to a space and device-based rules engine/module installed with one or more logical actions and response scripts, wherein said one or more logical actions and response scripts are configured to control space and device related parameters within the one or more selected spaces in the IoT setting.

2. The system of claim 1 wherein the at least one server is a cloud-based server.

3. The system of claim 1 wherein the at least one database contains information regarding the “state” of the one or more sensors and the one of more devices within the one or more selected spaces.

4. The system of claim 1 wherein the at least one database receives/sends data bi-directionally, thereby supporting local and cloud-based control data.

5. The system of claim 1 wherein the one or more sensors include one or more environmental sensors, color/RGB sensors, and color temperature sensors.

6. (canceled)

7. The system of claim 1 wherein all the one or more logical actions and all the one or more response scripts are identical with all the one or more sensors and all the one or more electronic devices.

8. The system of clam 1 wherein script language describes the relationships of the one or more sensors to the one or more selected spaces.

9. (canceled)

10. The system of claim 1 wherein the one or more sensors detect and determine the number of human individuals or other objects within the setting in which the one or more sensor is installed, and wherein the one or more sensors detect and determine the position and orientation of each individual/object within the setting.

11. (canceled)

12. (canceled)

13. The system of claim 1 wherein the system is configured to allow dynamic integration of any new logical actions/response scripts.

14. The system of claim 1 wherein the system is configured to allow for dynamic future sensors to integrate into system without any change in the logical actions and response scripts.

15. The system of claim 1 wherein the system is configured to be installed in any existing IoT system.

16. The system of claim 1 wherein the at least one database includes one or more distributed databases communicatively coupled to at least one local gateway.

17. The system of claim 1 wherein the at least one cloud server is configured to manage received data from the at least one database and send back control data based on the preset logical actions/response scripts for controlling devices in the IoT environment.

18. The system of claim 1 wherein each at least one database reflects the current state of each one or more device and sensor and the set of device-based rules that govern each one or more device and sensor.

19. The system of claim 1 wherein the system is configured to allow for dynamic integration of new sets of logical actions/response scripts for controlling devices in the one or more selected spaces.

20. The system of claim 1 wherein the one or more devices include one or more luminaires or lighting devices.

21. The system of claim 1 wherein all rule or information changes are distributed in real time between the at least one of the at least one database and wherein conflicts are resolved based on a set of rules in real time.

22. (canceled)

23. (canceled)

24. (canceled)

25. The system of claim 1 wherein the device for exchanging data is a wireless device.

26. The system of claim 1 wherein the system operates and controls an illumination arrangement.

27. (canceled)

28. (canceled)

29. A method for providing rapid response and for controlling one or more devices connected within an IoT environment, comprising the steps of:
a. Collecting one or more data regarding status information of one or more devices in one or more spaces, via one or more spaces within the IoT environment;
b. Receiving all sensed data from multiple sensors within the IoT environment, via a wireless network, by at least one local gateway wherein the multiple sensors are included in the one or more devices;
c. Collecting all sensed data from at least one local gateway by one or more databases and sending the data to a remote cloud server system;
d. Processing and co-relating the receiving input data and sending one or more logical actions and response scripts by at least one cloud server to the distributed databases;
e. Sending output control data from the at least one databases to the one of the at least one local gateway that is associated with a particular space or spaces; and,
f. Controlling space and device related parameters via received control data within the one or more spaces within the IoT environment.
